(19) United States
(12) Patent Application Publication
(10) Pub. No.: US 2007/0006189 A1
(43) Pub. Date: Jan. 4, 2007

(54) Apparatus, system, and method of detecting modification in a self modifying code

(75) Inventors: Jianhui Li, Shanghai (CN); Oren Sasson, K. Motzkin (IL); Eric Lin, Shanghai (CN); Orna Eizion, Haifa (IL)

Correspondence Address: PEARL COHEN ZEDEK LATZER, LLP, 1500 BROADWAY, 12TH FLOOR, NEW YORK, NY, 10036, US

(73) Assignee: Intel Corporation

(21) Appl. No.: 11/170,075

(22) Filed: Jun. 30, 2005

(51) Int. Cl. G06F 9/45

(52) U.S. Cl. 717/141

(57) ABSTRACT

Embodiments of the invention provide a method of translating a block of source instructions to generate a block of target instructions; and, prior to executing the block of target instructions, determining whether one or more source instructions of the block of source instructions have been modified relative to the time the block of target instructions was generated. Embodiments of the invention also provide a method of, during execution of the target instructions, comparing a first memory range used by one or more write instructions of the block of target instructions with a second memory range used by the block of source instructions to determine whether the first memory range overlaps with the second memory range. Embodiments of the invention further provide apparatus, system, and machine-readable medium thereof.

### BACKGROUND OF THE INVENTION

A processor may execute a set of target instructions, referred to herein as target code, that is translated from a set of source instructions, referred to herein as source code. The source code may be stored or saved on a re-writeable medium such as, for example, a semiconductor memory. Some parts of the source code, e.g., one or more source instructions, may be modified between, for example, their translation into corresponding target instructions and the actual execution of the target instructions.

To ensure that the translated target instructions are reliable and consistent with the source instructions from which they are translated, a processor may need to detect possible modifications to the source instructions before executing the translated target instructions. If any modification to the source instructions is detected, the modified source instructions may need to be re-translated for execution.

To detect modifications, a comparison code may be inserted logically after each and every write or store instruction of a translated target code to perform in-line source code comparison. During execution of a group of target instructions, for example, target instructions between two write or store instructions, a comparison code may fetch corresponding current source instructions, and compare them with source instructions from the time target instructions were generated. When the comparison detects certain inconsistency between the two sets of source instructions, re-translation of the modified source instructions may be triggered. A comparison code may in general include multiple instructions such as, for example, loading, extracting, comparing and branching instructions, and all these instructions may need to be executed after each and every write or store target instructions where they are inserted.

### BRIEF DESCRIPTION OF THE DRAWINGS

The invention will be understood and appreciated more fully from the following detailed description of embodiments of the invention, taken in conjunction with the accompanying drawings of which:

FIG. 1 is a block diagram illustration of an apparatus capable of detecting modified and modifying source instructions during execution of corresponding target instructions according to some illustrative embodiments of the invention;

FIG. 2 is a schematic flowchart of a method of generating a block instruction comparison code through dynamic binary translation of a hyper-block of source instructions according to some illustrative embodiments of the invention;

FIG. 3 is a schematic flowchart of a method of generating memory range comparison codes through dynamic binary translation of a hyper-block of source instructions according to some illustrative embodiments of the invention;

FIG. 4 is a simplified illustration of a table used in the generation of memory range comparison codes according to some illustrative embodiments of the invention;

FIG. 5 is a schematic flowchart of a method of executing target instructions including block instruction comparison codes and memory range comparison codes according to some illustrative embodiments of the invention;

FIG. 6 is a schematic flowchart of a method of detecting modifications of source instructions through a block instruction comparison code according to some illustrative embodiments of the invention;

FIG. 7 is a schematic flowchart of a method of detecting modifications of source instructions through memory range comparison codes according to some illustrative embodiments of the invention; and

FIG. 8 is a simplified illustration of an address map of a memory used to save a hyper-block of source instructions and used by write instructions according to some illustrative embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods and procedures have not been described in detail so as not to obscure the embodiments of the invention.

Some portions of the detailed description in the following are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or, computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software The machine-readable medium or article may include, for example, any suitable type of memory unit, memory device, memory article, memory medium, storage device, storage article, storage medium and/or storage unit, e.g., memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, target code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Embodiments of the invention may include apparatuses for performing the operations herein. These apparatuses may be specially constructed for the desired purposes, or they may include a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROM), random access memories (RAM), electrically programmable read-only memories (EPROM), electrically erasable and programmable read only memories (EEPROM), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. It will be appreciated that a variety of programming languages may be used to implement the teachings of the invention as described herein.

In the following description, various figures, diagrams, flowcharts, models, and descriptions are presented as different means to effectively convey the substances and illustrate different embodiments of the invention that are proposed in this application. It shall be understood by those skilled in the art that they are provided merely as illustrative samples, and shall not be constructed as limitation to the invention.

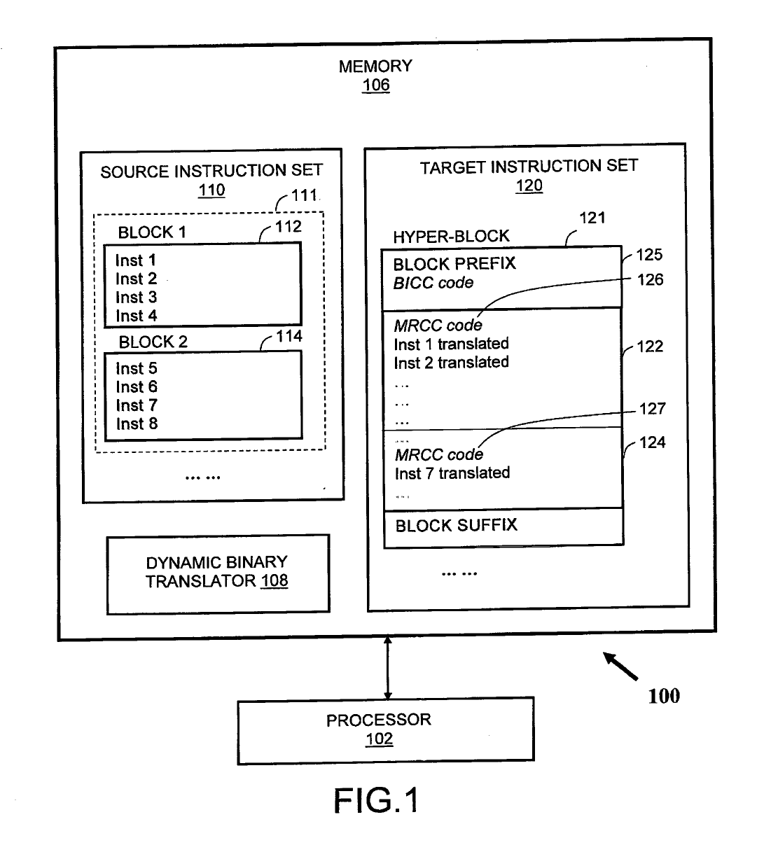

FIG. 1 is a block diagram illustration of an apparatus 100 capable of detecting modified and modifying source instructions during execution of corresponding target instructions according to some illustrative embodiments of the invention. Apparatus 100 may be, for example, a computing platform including a processor 102 and a memory 106. Memory 106 may be operatively connected to processor 102. Memory 106 may store thereon a binary code of a dynamic binary translator 108, and may in addition store a set of source instructions 110 and a set of target instructions 120, which may be translated from source instructions 110 by binary translator 108.

A non-exhaustive list of examples for apparatus 100 may include a desktop personal computer, a work station, a server computer, a laptop computer, a notebook computer, a hand-held computer, a personal digital assistant (PDA), a mobile telephone, a game console, and the like.

A non-exhaustive list of examples for processor 102 may include a central processing unit (CPU), a digital signal processor (DSP), a reduced instruction set computer (RISC), a complex instruction set computer (CISC) and the like. Moreover, processor 102 may be part of an application specific integrated circuit (ASIC) or may be a part of an application specific standard product (ASSP).

A non-exhaustive list of examples for memory 106 may include one or any combination of the following semiconductor devices, such as synchronous dynamic random access memory (SDRAM) devices, RAMBUS dynamic random access memory (RDRAM) devices, double data rate (DDR) memory devices, static random access memory (SRAM) devices, flash memory (FM) devices, electrically erasable programmable read only memory (EEPROM) devices, non-volatile random access memory (NVRAM) devices, universal serial bus (USB) removable memory devices, and the like; optical devices, such as compact disk read only memory (CD ROM), and the like; and magnetic devices, such as a hard disk, a floppy disk, a magnetic tape, and the like. Memory 106 may be fixed within or removable from apparatus 100.

According to illustrative embodiments of the invention, the set of source instructions 110 stored in memory 106 may be partitioned, as is known in the art, into one or more basic blocks, for example, blocks 112 and 114. Source instruction set 110 may comply with a source architecture. A non-limiting example for the source architecture is the Intel® architecture-32 (IA-32). In some embodiments, basic blocks 112 and 114 may be frequently executed, and may be referred to herein collectively as a hyper-block, for example, a hyper-block 111. A “hyper-block”, as defined in this application, may include one or more basic blocks.

According to illustrative embodiments of the invention, target instruction set 120 may include one or more target code blocks, for example, blocks 122 and 124. Target instruction set 120 may comply with a target architecture. A non-limiting example for the target architecture is the Intel® architecture-64 (IA-64). Target code blocks 122 and 124 may form a target hyper-block, for example, a target hyper-block 121, corresponding to source hyper-block 111 of basic blocks 112 and 114.

According to illustrative embodiments of the invention, hyper-block 121 may include a block instruction comparison code (“BICC”), for example, BICC 125, which may be attached as a prefix to the body of the translated target code blocks 122 and 124. A BICC, e.g., BICC 125, according to embodiments of the invention, may compare current source instructions with source instructions from the time the target instructions of the block were generated, thereby to detect any inconsistency in the source code. Inconsistencies detected by the BICC may be caused by write or store instructions in other hyper-blocks of target code.

According to illustrative embodiments of the invention, target code blocks 122 and 124 may include one or more memory range comparison codes (“MRCC”), for example, MRCC's 126 and 127 MRCC's 126 and 127 may be related to, and may be placed before, one or more write instructions; however, in some embodiments, MRCC's 126 and/or 127 may be placed after the corresponding write instructions. A MRCC may compare a memory range used by one or more write instructions and a memory range used to save the source instructions to detect any memory range overlap.

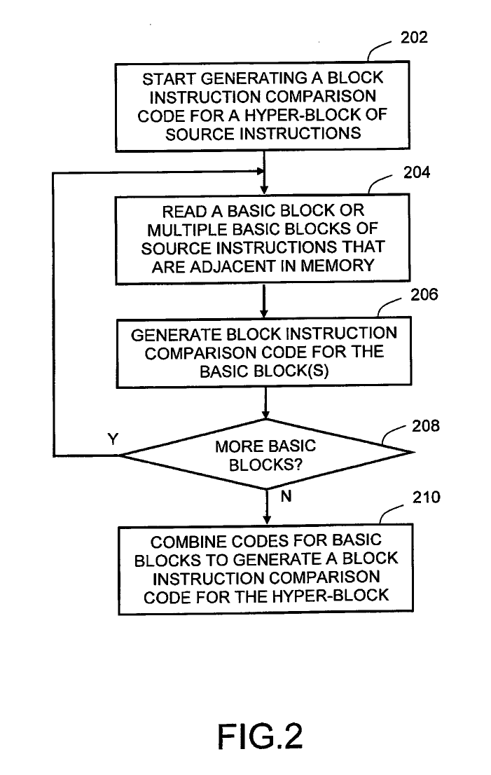

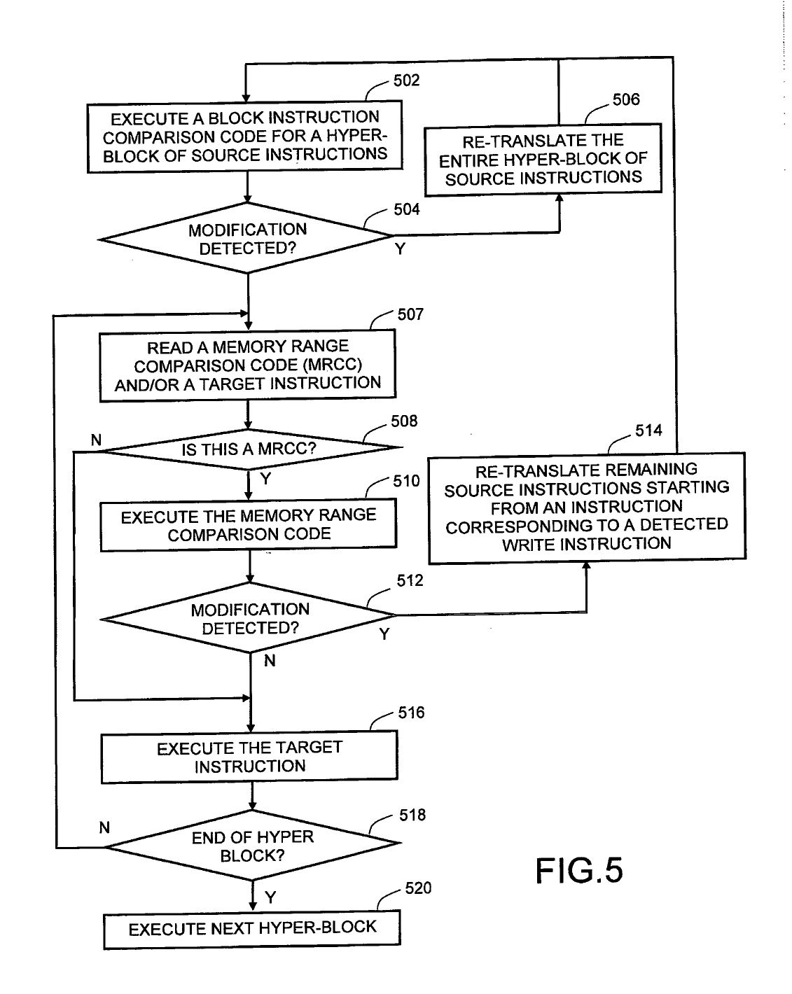

Generation of BICC's, e.g., BICC 125, and MRCC's, e.g., MRCC's 126 and 127, is described in detail below with reference to FIGS. 2-4. Execution of BICC's and MRCC's is described in detail below with reference to FIGS. 5-8.

FIG. 2 is a schematic flowchart of a method of generating a block instruction comparison code through dynamic binary translation of a hyper-block of source instructions according to some illustrative embodiments of the invention. The BICC is attached as a prefix to a hyper-block of target instructions (“target block”) which is generated from translating the hyper-block of source instructions (“source block”), and may include one or more instruction comparison codes for one or more basic blocks in the hyper-block of source instructions. The BICC may, when being executed, compare current source instructions with original source instructions from the time the target instructions were generated, thereby to detect possible code modifications to the source instructions.

According to illustrative embodiments of the invention, dynamic binary translator 108 may start generating a block instruction comparison code for a hyper-block of source instructions, as indicated at block 202. Dynamic binary translator 108 may read, as indicated at block 204, a basic block of the source instructions or source code, or multiple basic blocks that are adjacent in memory, and may generate a BICC for the basic block or basic blocks, as indicated at block 206.

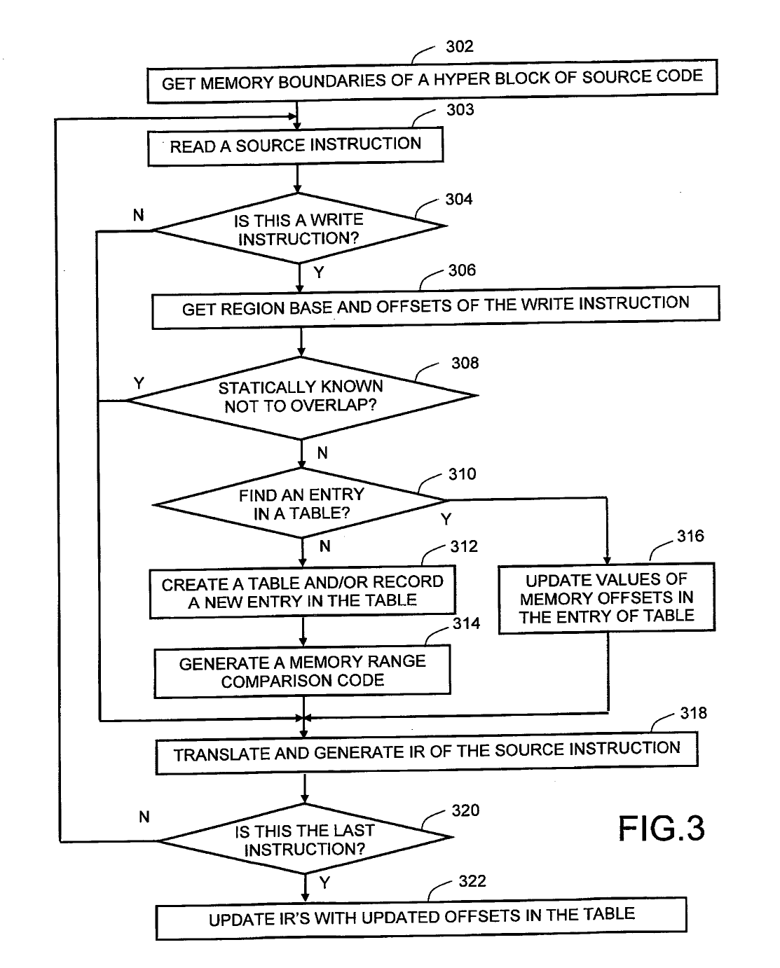

As indicated at block 208, dynamic binary translator 108 may then determine whether there are more basic blocks inside the hyper-block of source instructions. If the hyper-block includes more basic block or blocks, binary translator 108 may then read a new basic block, and generate a BICC for the new basic block, as described above with reference to blocks 204 and 206. If at block 208, BICC's have been generated for all the basic blocks of the hyper-block, dynamic binary translator 108 may proceed to generate a BICC for the hyper-block of source instructions, by combining all the BICC's for the individual basic blocks, as indicated at block 210. The combined BICC may be attached as a prefix to the hyper-block of target instructions to be generated from translating the hyper-block of source instructions as described in detail below with reference to FIG. 3.

FIG. 3 is a schematic flowchart of a method of generating memory range comparison codes through dynamic binary translation of a hyper-block of source instructions according to some illustrative embodiments of the invention.

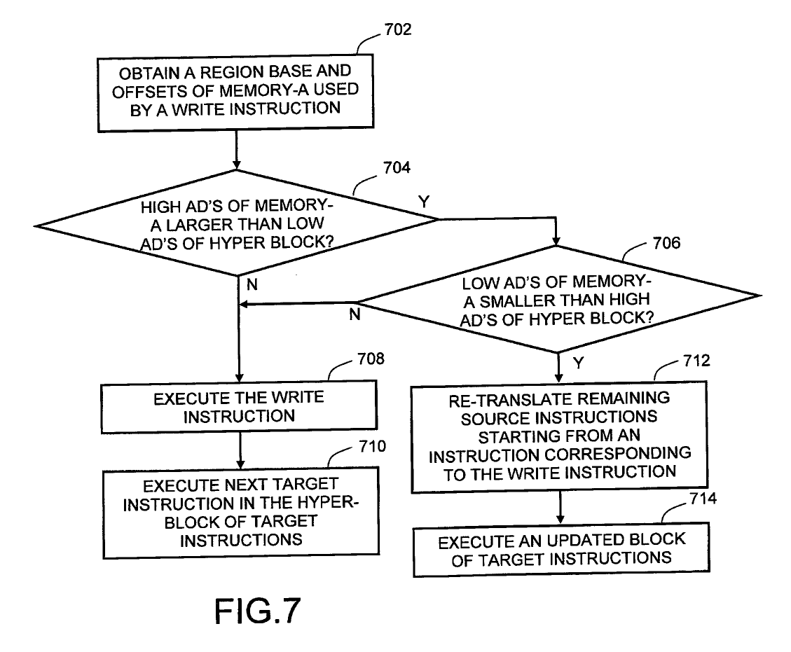

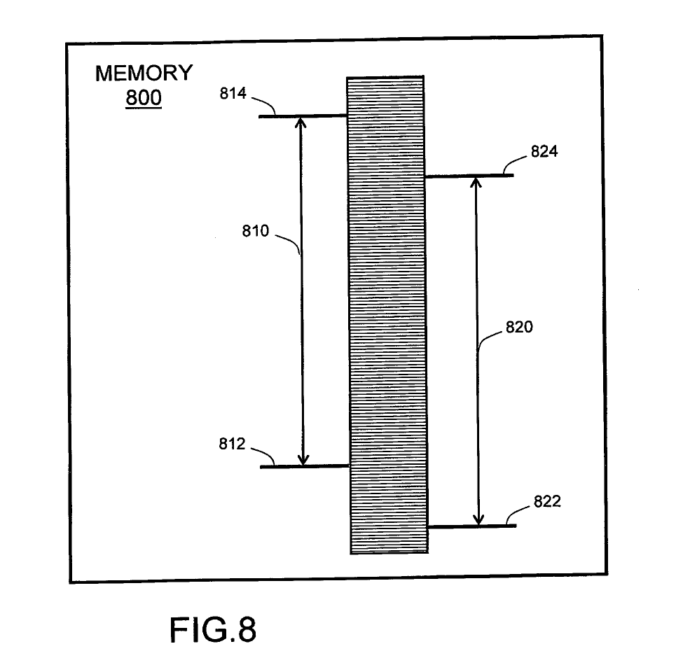

According to illustrative embodiments of the invention, dynamic binary translator 108 may proceed to translate the hyper-block of source instructions or source code into a corresponding hyper-block of target instructions or target code. Dynamic binary translator 108 may get memory boundaries of the hyper-block of source code as indicated at block 302. Dynamic binary translator 108 may then proceed to read a source instruction, as indicated at block 303, and determine whether the source instruction is a write instruction, as indicated at block 304. If the source instruction is a write instruction, dynamic binary translator 108 may get information relating to a memory range used by the write instruction, as indicated at block 306, which may include a region base and upper and lower memory offsets. Dynamic binary translator 108 may then proceed, as indicated at block 308, to determine whether the memory range used by the write instruction is statically known to overlap with a memory range used to save the hyper-block, which is obtained as described above at block 302. If the memory range used by the write instruction is not statically known, for example, the memory range used by the write instruction includes an address value which is dynamically determined, the memory range may of may not overlap with the memory range saving the hyper-block. Whether the two memory ranges overlap or not depends on the address value calculated during execution of the write instruction. Dynamic binary translator 108 may therefore need to generate a MRCC. The MRCC may determine whether the two memory ranges overlap, as described in detail below with reference to FIGS. 7 and 8, during target code execution.

According to illustrative embodiments of the invention, in order to help generate the MRCC, dynamic binary translator 108 may temporarily create a table to store or record information relating to one or more write instructions. However, the invention is not limited in this respect and it will be appreciated by a person skilled in the art that other means may be used to help create the MRCC.

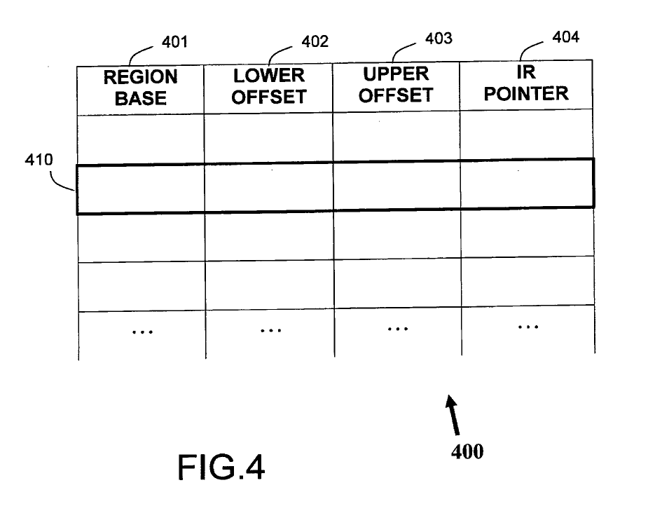

Reference is made to FIG. 4, which is a simplified illustration of a table 400 used in the generation of memory range comparison codes according to some illustrative embodiments of the invention. Table 400 may have one or more entries related to one or more write instructions. Each entry, e.g., entry 410, may include information relating to, e.g., a memory region base 401, a lower memory offset 402, and an upper memory offset 403 used by the write instruction. Entry 410 may also include at least one pointer 404 which points to an intermediate representation (“IR”) of a corresponding MRCC for the write instruction, but the invention is not limited in this respect. Other IR's used by the MRCC may also be stored in Table 400. Several write instructions using memory ranges that are adjacent may share a single MRCC as described in detail below. Table 400 may be created in a memory area such as, for example, memory 106 or an instruction cache of processor 102.

Reference is now made back to FIG. 3. If the memory range used by the write instruction is not statically known whether overlapping with the memory range of the hyper-block of source code, as indicated at block 308, binary translator 108 may need to generate a MRCC for the write instruction. As indicated at block 310, dynamic binary translator 108 may determine whether there is an existing region-base entry in Table 400 that is the same as the region base of the write instruction and variables of the region base have not been changed.

According to illustrative embodiments of the invention, if an entry having a same region base exists in Table 400 and the variables of the region base are not changed, the current write instruction may share a MRCC which may be generated later for the existing entry, and there is no need to generate a separate MRCC for the current write instruction. In this case, dynamic binary translator 108 may proceed to update values of the upper and lower memory offsets in the entry as indicated at block 316. As a result, the memory range covered by the updated upper and lower offsets may include the memory range covered by the existing upper and lower offsets and the memory range handled by the current write instruction.

According to illustrative embodiments of the invention, if there is no same region base is found in Table 400, as indicated at block 310, a new entry may be recorded or created in Table 400, as indicated at block 312, to save the region base and upper and lower memory offsets of the current write instruction, together with a pointer pointing to the IR of a MRCC to be generated for the current write instruction. According to illustrative embodiments of the invention, If Table 400 does not exist yet, it is created at block 312. Following the recordation and/or creation of the new entry in Table 400, a MRCC is generated for the current write instruction, as indicated at block 314.

According to illustrative embodiments of the invention, if at block 304 it is determined that the instruction is not a write instruction, or if at block 308 the memory range used by the write instruction is statically known not to overlap with the memory range used in saving the hyper-block of source instructions, or if at block 314 a MRCC is generated, or if at block 316 the upper and lower memory offsets have been updated in Table 400, dynamic binary translator 108 may proceed to translate the source instruction, as indicated at block 318, by generating IR, for example, for the source instruction. The generated target instruction may be placed, for example, after the MRCC generated at block 314, but the invention is not limited in this respect. The generated target instruction may alternatively be placed before the MRCC.

According to illustrative embodiments of the invention, dynamic binary translator 108 may further determine, as indicated at block 320, whether the last source instruction of the hyper-block has been reached. If this is the last source instruction, dynamic binary translator 108 may proceed to update IR's pointed by the pointers, for example, pointer 404 in Table 400, with updated upper and lower memory offsets recorded in Table 400, as indicated at block 322. If there are mole source instructions to be translated, dynamic binary translator 108 may proceed to read a new source instruction, as indicated at block 303, and may repeat the creation of the MRCC as described above, with reference to blocks 304-318.

FIG. 5 is a schematic flowchart of a method of executing target instructions including block instruction comparison codes and memory range comparison codes according to some illustrative embodiments of the invention.

According to illustrative embodiments of the invention, processor 102 may execute a BICC, as indicated at block 502, before executing a hyper-block of target code. Throughout this application, wherever a processor, for example, processor 102, is described as performing one or more actions such as, for example, determining, detecting, and/or executing, the description means that such actions may be performed by the processor alone, or in combination with any other devices and/or units that are internal or external to, for example, apparatus 100. Further, such actions may be performed directly by the processor and/or indirectly through the processor executing a set of instructions and/or a program code.

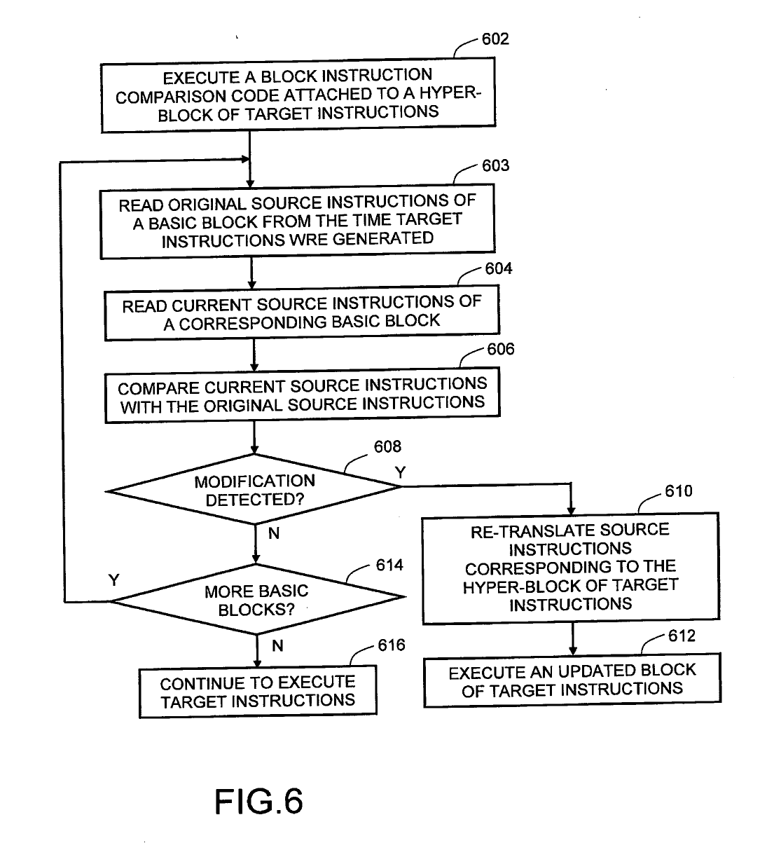

Processor 102 may determine, through the execution of the BICC, for example, BICC 125, whether one or more source instructions of the hyper-block of source instructions have been modified relative to the time the hyper-block of target code was generated. Execution of the BICC is described in detail below reference to FIG. 6.

According to illustrative embodiments of the invention, if at block 504 it is determined that there are modifications to one or more of the source instructions inside the hyper block, in other words modifications are detected, the control of target code execution may be transferred to dynamic binary translator 108, which may proceed to re-translate the entire updated hyper-block of source instructions (“updated source block”) or source code, as indicated at block 506, thereby to generate an updated block of target instructions (“updated target block”). The re-translation of source instructions may include re-generation of a BICC for the hyper-block and one or more MRCC's for write instructions inside the hyper-block, as described in detail above with reference to FIGS. 2 and 3. Processor 102 may then proceed to execute the updated block of target instructions, starting at block 502. If no modification to source instructions is detected at block 504, processor 102 may proceed to execute the generated target instructions as described in detail below.

According to illustrative embodiments of the invention, processor 102 may proceed to read a target instruction and possibly a MRCC, as indicated at block 507. A MRCC may precede a target instruction if the target instruction is a write instruction. However, the invention is not limited in this respect. For example, a write instruction may share a MRCC with another write instruction, as described in detail above with reference to FIG. 3, and therefore may not have a preceding MRCC. As indicated at block 508, processor 102 may then determine whether the instruction read is a MRCC. If it is a MRCC, for example, MRCC 126, the MRCC may be executed at block 510. Execution of a MRCC is described in detail below with reference to FIG. 7. If it is determined that the write instruction corresponding to the MRCC may cause memory range overlap and therefore cause code modification, as indicated at block 512, the write instruction is a modifying instruction. For example, if potential code modification is detected at block 512, the control of the code execution may be transferred to dynamic binary translator 108. As indicated at block 514, dynamic binary translator 108 may proceed to re-translate the remaining source instructions starting at an instruction corresponding to the detected modifying write instruction, thereby to generate an updated block of target instructions. Processor 102 may then execute the updated block of target instructions as indicated at block 502.

According to illustrative embodiments of the invention, if it is determined at block 508 that the instruction read by processor 102 is not a MRCC but a regularly generated target instruction, or if at block 512 no code modification is detected, processor 102 may proceed to execute the following target instruction as indicated at block 516.

According to illustrative embodiments of the invention, after the execution of the target instruction, processor 102 may proceed to determine, as indicated at block 518, whether the end of the hyper-block of target instructions has been reached. If the end of the hyper-block has not yet been reached, indicating that there are more target instructions to be executed, processor 102 may proceed to execute the next target instruction and possibly a MRCC as described above, by returning to block 507. If it is determined, as indicated at block 518, that the end of the hyper-block has been reached, processor 102 may proceed to execute the next hyper-block of target instructions, as indicated at block 520. The execution of the next hyper-block of target instructions may start as indicated at block 502.

According to illustrative embodiments of the invention, a write instruction may not always have a corresponding MRCC. As is described above with reference to FIG. 3, a MRCC may be shared by one or more write instructions if, for example, the memory ranges used by the write instructions are adjacent to each other. In addition, a memory range used by a write instruction may be statically known not to overlap with that of the hype-block of source instructions, and therefore a MRCC may not be necessarily generated.

FIG. 6 is a schematic flowchart of a method of detecting modification of source instructions through a block instruction comparison code according to some illustrative embodiments of the invention.

Before executing a hyper-block of target instructions (“target block”) generated from a hyper-block of source instructions (“source block”), processor 102 may execute a BICC, which is attached as a prefix to the target block of target instructions, to determine whether modifications have been made to the source block of source instructions. The BICC may compare an updated version of the hyper-block of source instructions with the original code of the same hyper-block, from the time the corresponding target instructions were generated. The comparison may be made per basic blocks that make up the hyper-block.

According to illustrative embodiments of the invention, processor 102 may start executing a BICC attached to a hyper-block of target instructions as indicated at block 602. Processor 102 may read or obtain original source instructions of a basic block from the time the target instructions were generated, as indicated at block 603. The original source instructions may be encoded or embedded in the BICC, for example, MICC 125, but the invention is not limited in this respect. For example, in some embodiments, the original source instructions may be stored in a memory, for example, memory 106 separate from the BICC. Processor 102 may also read or obtain from a memory, for example, memory 106, an updated version of the source instructions corresponding to the basic block, for example, basic block 112, as indicated at block 604. Processor 102 may compare the contents of the updated version of source instructions with the contents of original source instructions, as indicated at block 606, to determine whether code modifications have been made, as indicated at block 608.

According to illustrative embodiments of the invention, if it is determined there is no source code modification as indicated at block 608, processor 102 may proceed to determine, at block 614, whether there are more basic blocks inside the hyper-block that need to be checked for code modification. If there are more basic blocks that need to be checked for code modification, processor 102 may return to read the original source instructions of the next basic, as indicated at block 603, and to read current source instructions of the corresponding basic block, as indicated at block 604, and repeat the procedure as described above with reference to blocks 606 and 608 to determine whether or not there are code modifications to the source instructions.

According to illustrative embodiments of the invention, if at block 614 it is determined that all the basic blocks have been verified of no modification to the source instructions, processor 102 may proceed to execute the target instructions, including one or more MRCC's, generated from the translation of the hyper-block of source instructions, as described in detail below with reference to FIG. 7.

According to illustrative embodiments of the invention, if at block 608, modification to the source code is detected, control of the target code execution may be transferred to dynamic binary translator 108. Dynamic binary translator 108 may proceed to retranslate all the source instructions corresponding to the hyper-block of target instructions, as indicated at block 610, to generate an updated block of target instructions. Processor 102 may then execute the updated block of target instructions as indicated at block 612, and described in detail above with reference to FIG. 5.

FIG. 7 is a schematic flowchart of a method of detecting modification of source instructions through memory range comparison codes according to some illustrative embodiments of the invention.

Following executing a BICC as described in detail above with reference to FIG. 6, processor 102 may proceed to execute target instructions generated from the hyper-block of source instructions. One or more write instructions inside the hyper-block may cause source code modification and the modification may be detected by one or more MRCC's inside the hyper-block of target instructions as described in detail below.

Reference is made to FIG. 8, which is a simplified illustration of an address map of a memory used to save a hyper-block of source instructions and used by write instructions according to some illustrative embodiments of the invention. The hyper-block of source instructions is stored in a memory range 810 which has a low address 812 and a high address 814. A write instruction of the hyper-block of source instructions may write to a memory range 820, which has a low address 822 and a high address 824.

Reference is now made back to FIG. 7. According to illustrative embodiments of the invention, a source instruction may be a write instruction. Before executing the write instruction, through the execution of a corresponding target instruction, processor 102 may determine whether the hyper-block of source instructions may be modified by the execution of the target instruction. Processor 102 may execute a MRCC, for example, MRCC 126, to obtain information relating to a memory range, for example, memory range 820 (“Memory-A”), used by the write instruction as indicated at block 702. For example, processor 102 may obtain a region base and upper and lower offset values of the memory range 820. The information may be encoded in the MRCC which correspond to an entry, e.g., entry 410, of Table 400. A low address 822 of memory range 820 may be calculated by adding the region base with the lower offset. A high address 824 of memory range 820 may be calculated by adding the region base with the upper offset.

According to illustrative embodiments of the invention, processor 102 may compare memory range 820 with a memory range, for example, memory range 810 (“Memory-S”), wherein the hyper-block of source instructions is stored. Memory range 810 of the hyper-block may have a low address 812 and a high address 814, which may be obtained as described in detail above with reference to FIG. 2. Dynamic binary translator 108 may compare low address 822 and high address 824 of Memory-A, with low address 812 and high address 814 of Memory-S, respectively, as described in detail below.

According to illustrative embodiments of the invention, if high address 824 of memory-A is smaller than low address 812 of memory-S, it may be determined, as indicated at block 704, that memory ranges A and S may not overlap with each other. Therefore, processor 102 may proceed to safely execute the write instruction, as indicated at block 708, and subsequently proceed to execute next target instruction in the hyper-block of tar get instructions as indicated at block 710.

According to illustrative embodiments of the invention, if high address 824 of memory-A is larger than low address 812 of memory-S, it is possible that memory A and S may overlap with each other. Therefore, processor 102 may need to further determine whether or not low address 822 of memory-A is less than high address 814 of memory-S as indicated at block 706.

According to illustrative embodiments of the invention, if low address 822 of memory-A is larger than high address 814 of memory-S, it may be determined that the range of memory-A may be above the range of memory-S, and therefore memory-A and S may not over lap with each other, as indicated at block 706. Therefore, processor 102 may proceed to safely execute the write instruction, as indicated at block 708, and subsequently proceed to execute next target instruction in the hyper-block of target instructions as indicated at block 710.

According to illustrative embodiments of the invention, if low address 822 of memory-A is smaller than high address 814 of memory-S, then the range of memory-A may overlap with the range of memory-S. An overlap in memory range may be an indication that the original source instructions may be modified by the write instruction, which is referred to herein as a modifying write instruction. Therefore, following the determination at block 706, control of the execution of target instructions may be transferred to dynamic binary translator 108. Dynamic binary translator 108 may proceed to re-translate the remaining source instructions, at block 712, e.g., starting from an instruction corresponding to the write instruction that may cause memory range overlap, to generate an updated block of target instructions. Subsequently, as indicated at block 714, processor 102 may proceed to execute the updated block of target instructions, as described in detail above with reference to FIG. 5.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spit it of the invention.

What is claimed is:

1. A method comprising:
translating a source block to generate a target block; and
prior to executing said target block, determining whether one or more source instructions of said source block have been modified relative to the time said target block was generated.

2. The method of claim 1, wherein determining whether one or more source instructions have been modified comprises comparing the contents of said source block with the contents of an updated version of said source block.

3. The method of claim 2, further comprising:
if one or more of said source instructions have been modified, translating said updated version of said source block to generate an updated target block; and
executing said updated tar get block.

4. The method of claim 2, comprising:
attaching as a prefix to said target block a block instruction comparison code,
wherein determining whether one or more source instructions of said source block have been modified comprises comparing the contents of said source block with the contents of said updated version of said source block using said block instruction comparison code.

5. The method of claim 1, further comprising:
during execution of said target block, comparing a first memory range used by one or more write instructions of said target block with a second memory range used by said source block; and
determining whether said first memory range overlaps with said second memory range.

6. The method of claim 5, further comprising:
if one of said write instructions causes said first memory range to overlap with said second memory range, translating an updated version of said source block to generate an updated target block; and
executing said updated target block.

7. The method of claim 6, wherein translating said updated version of said source block comprises translating said updated version starting from a source instruction corresponding to said write instruction causing said memory ranges to overlap.

8. The method of claim 5, comprising:
insetting a memory range comparison code into said target block,
wherein determining whether said first memory range overlaps with said second memory range comprises comparing said first memory range with said second memory range using said memory range comparison code.

9. The method of claim 8, wherein said first and second memory ranges have a region base, a lower offset, and an upper offset defining a low and a high address, wherein comparing said first memory range with said second memory range comprises comparing said low and high addresses of said first memory range with said low and high addresses of said second memory range.

10. An apparatus comprising:
a dynamic binary translator to translate a source block to generate a target block; and
a processor to determine, prior to executing said target block, whether one or more source instructions of said source block have been modified relative to the time said target block was generated.

11. The apparatus of claim 10, wherein said processor is able to determine whether one or more source instructions have been modified by comparing the contents of said source block with the contents of an updated version of said source block.

12. The apparatus of claim 11, wherein said dynamic binary translator is able to translate said updated version of said source block to generate an updated target block, and wherein said processor is able to execute said updated target block.

13. The apparatus of claim 11, wherein said dynamic binary translator is able to attach to said target block a block instruction comparison code to be used by said processor in comparing the contents of the source block and the updated version of the source block.

14. The apparatus of claim 10, wherein said processor is able, during execution of said target block, to compare a first memory range used by one or more write instructions of said target block with a second memory range used by said source block, and to determine whether said first memory range overlaps with said second memory range.

15. The apparatus of claim 14, wherein said dynamic binary translator is able to translate an updated version of said source block to generate an updated target block, and said processor is able to execute said updated target block.

16. The apparatus of claim 15, wherein said dynamic binary translator is able to translate said updated version of said source block starting from a source instruction corresponding to said write instruction causing said memory ranges to overlap.

17. The apparatus of claim 14, wherein said dynamic binary translator is able to insert into said target code a memory range comparison code to be used by said processor in comparing said first and second memory ranges.

18. The apparatus of claim 16, wherein said first and second memory ranges have a region base, a lower offset, and an upper offset defining a low and a high address, wherein said processor is able to compare said low and high addresses of said first memory range with said low and high addresses of said second memory range.

19. A system comprising:
a dynamic binary translator to translate a source block to generate a target block; and
a processor to determine, prior to executing said target block, whether one or more source instructions of said source block have been modified relative to the time said target block was generated; and
a memory to store said source block, said target block, and said dynamic binary translator.

20. The system of claim 19, wherein said processor is able to determine whether one or more source instructions have been modified by comparing the contents of said source block with the contents of an updated version of said source block.

21. The system of claim 19, wherein said processor is able, during execution of said target block, to compare a first memory range used by one or more write instructions of said target block with a second memory range used by said source block, and to determine whether said first memory range overlaps with said second memory range.

22. A machine-readable medium having stored thereon a set of instructions that, when executed by a machine, result in translating a source block to generate a target block; and, prior to executing said target block, determining whether one or more source instructions of said source block have been modified relative to the time said target block was generated.

23. The machine-readable medium of claim 22, wherein the instructions result in comparing the contents of said source block with the contents of an updated version of said source block.

24. The machine-readable medium of claim 22, wherein the instructions result in, during execution of said target block, comparing a first memory range used by one or more write instructions of said target block with a second memory range used by said source block, and determining whether said first memory range overlaps with said second memory range.
